(19) United States
(12) Patent Application Publication
(10) Pub. No.: US 2002/0013824 A1
(43) Pub. Date: Jan. 31, 2002

(54) Home delivery system and home delivery method capable of efficiently delivering package

(75) Inventor: Makoto Endou, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/911,422

(22) Filed: Jul. 25, 2001

(30) Foreign Application Priority Data
Jul. 25, 2000 (JP) 224451/2000

(51) Int. Cl. G06F 15/16

(52) U.S. Cl. 709/218; 709/203

(57) ABSTRACT

A home delivery system to which this invention is applicable is comprising a sender terminal unit, a receiver terminal unit, and a distribution center unit connected to the sender terminal unit and the receiver terminal unit through a network. The distribution center unit receives from the sender terminal unit a request specification information for requesting to deliver a package, picks up from the request specification information a sender identity information of a sender end, and generates by referring to the sender identity information a collecting direction information for directing a distribution center to pick up the package.

### BACKGROUND OF THE INVENTION

This invention relates to a home delivery system comprising a sender terminal unit, a receiver terminal unit, and a distribution center unit connected to the sender terminal unit and the receiver terminal unit through a network, and particularly relates to a home delivery system capable of contributing delivery of a package in high efficiency.

Conventionally, a package sent from a sender is delivered to a receiver as follows. The sender brings the package into a delivery agency and takes the predetermined procedure to the delivery agency for delivering the package. A delivery dealer collects the package from the delivery agency and sends the package to a delivery center covering a delivery district where the receiver lives. The package is delivered from the delivery center to the receiver.

However, a conventional home delivery system mentioned above has the problems as follows.

First, the sender must bring the package to the delivery agency and therefore is labored. Particularly, if the package is large and/or heavy, the sender is more labored.

Secondary, if the receiver is not home when the deliver dealer delivers the package to the receiver, the deliver dealer must visit the receiver again to hand the package to the receiver. Therefore, the deliver dealer is also labored and this work is inefficient as business.

### SUMMARY OF THE INVENTION

It is therefore an object of this invention to provide a home delivery system capable of efficiently delivering a package.

The other objects, features, and advantages of this invention will become clear as the description proceeds.

This invention is directed to a home delivery system comprising a sender terminal unit installed at a sender end requesting to send a package, a receiver terminal unit installed at a receiver end for to receive the package, and a distribution center unit installed at a distribution center collecting and delivering the package and connected to the sender terminal unit and the receiver terminal unit through a network. The distribution center unit receives from the sender terminal unit a request specification information for requesting to deliver the package, picks up from the request specification information a sender identity information of the sender end, and generates by referring to the sender identity information a collecting direction information for directing the distribution center to pick up the package.

### BRIEF DESCRIPTION OF THE DRAWINGS

FIG. 1 is a block diagram showing a home delivery system according to a first embodiment of this invention;

FIG. 2 is a flow chart for illustrating the working of the home delivery system shown in FIG. 1;

FIG. 3 shows an example of a request specification information displayed on a display of the home delivery system, for illustrating the working of the home delivery system shown in FIG. 1;

FIG. 4 is a block diagram showing a home delivery system according to a second embodiment of this invention; and

FIG. 5 is a flow chart for illustrating the working of the home delivery system shown in FIG. 4;

### DESCRIPTION OF THE PREFERRED EMBODIMENTS

Now, preferred embodiments of this invention will be described with reference to the attached drawings.

First Embodiment

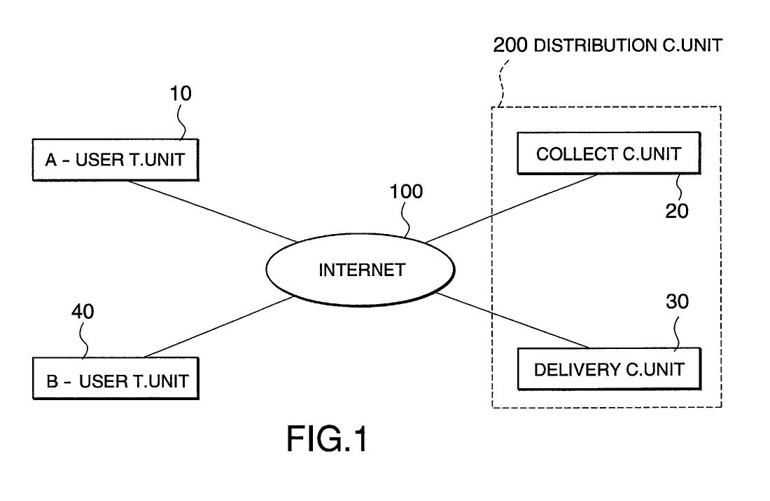

Referring to FIG. 1, a home delivery system according to a first embodiment of this invention comprises an A-user terminal unit 10 as a sender terminal unit, a B-user terminal unit 40 as a receiver terminal unit, and a distribution center unit 200 connected to the A-user terminal unit 10 and the B-user terminal unit 40 through Internet 100 as a network. The distribution center unit 200 includes a collect center unit 20 and a delivery center unit 30.

The A-user terminal unit 10 is implemented by an information processing apparatus such as a personal computer and installed at an A-user end as a sender end requesting to send a package. The A-user terminal unit 10 can access and display a service webpage putting up a delivery service information. The webpage is provided through the Internet 100 by the collect center unit 20 and/or the delivery center unit 30 of a delivery dealer. The delivery service information includes a menu or a user interface for inputting a request specification information by the A-user. For example, the request specification information includes a name, an outward size, and a weight of the package and an identity such as an address and/or a network address of the A-user (a sender). The request specification information is used for requesting by A-user terminal unit 10 to deliver the package and for identifying by the distribution center unit 200 as follows. Furthermore, the A-user terminal unit 10 can send the request specification information to the collect center unit 20 through the Internet 100.

The collect center unit 20 and the delivery center unit 30 are implemented by an information processing apparatus such as a workstation or a server and used by the delivery dealer, respectively.

The collect center unit 20 is installed at a collect center. The collect center unit 20 can receive from the A-user terminal unit 10 the request specification information and can generate by referring to the request specification information a package identity information of the package. Furthermore, the collect center unit 20 can send the package identity information to the delivery center unit 30 and the B-user terminal unit 40 through the Internet 100. The package identity information is generated at every time when a deliver is requested and is used for identifying the sender, the package, and a receiver of the package.

Furthermore, the collect center unit 20 can generate a package information by adding to the package identity information an information for directing the delivery center to visit the B-user (a receiver) . The B-user lives in a district covered by the collect center. The collect center unit 20 can send the package information to the delivery center unit 30.

Furthermore, the collect center unit 20 can send to the B-user terminal unit 40 by referring to an information of the B-user included in the package identity information a delivery information for asking by the A-user the desired date and time for receiving the package at the home of the B-user.

The B-user terminal unit 40 is implemented by the information processing apparatus such as the personal computer and installed at a B-user end as a receiver end receiving the package. The B-user terminal unit 40 can receive the delivery information sent from the collect center unit 20.

Furthermore, the B-user terminal unit 40 can generate by referring to the delivery information a delivery direction information for directing by the B-user to deliver the package and can send to the delivery center unit 30 the delivery direction information through the Internet 100.

The delivery center unit 30 is installed at a delivery center. The delivery center unit 30 can receive the package information sent from the collect center unit 20.

Furthermore, the delivery center unit 30 can receive the delivery direction information sent from the B-user by the use of the B-user terminal unit 40. The delivery direction information represents the desired date and time for receiving the package at the home of the B-user. The dealer of the delivery center delivery, by referring to the delivery direction information, the package temporarily received from the collect center to the B-user on the desired date and time directed by the B-user.

The delivery center unit 30 can send to the A-user terminal unit 10 and the collect center unit 20 a delivery finish information representing that the package has been delivered to the B-user. The delivery finish information is generated in the B-user terminal unit 40 by the input by the B-user. Therefore, the delivery finish information may be directly sent from the B-user terminal unit 40 to the A-user terminal unit 10 and the collect center unit 20.

The Internet 100 in this invention may include another communication network such as a local area network (LAN) and/or a wide area network (WAN).

Next, the working of the home delivery system shown in FIG. 1 will be described with reference to FIGS. 1 to 3.

The collect center unit 20 discloses the service webpage. The A-user terminal unit 10 accesses to the service webpage by handling by the A-user as the sender of the package through the Internet 100 (Step A1). When the collect center unit 20 is accessed by the A-user terminal unit 10, the collect center unit 20 sends to the A-user terminal unit 10 the delivery service information menu for inputting by the A-user the request specification information (Step A2).

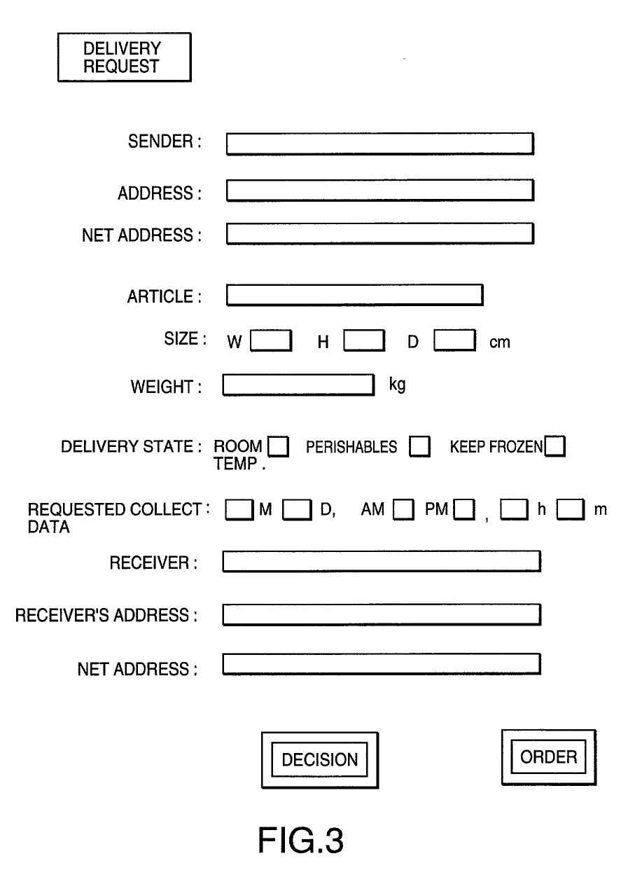

The A-user terminal unit 10 displays on a display (not shown) thereof the delivery service information menu as shown in FIG. 3 (Step A3). The A-user terminal unit 10 as the user interface receives inputting by the A-user items of the delivery service information menu (A4).

Inputting the items is carried out as follows. Referring to FIG. 3, the A-user clicks by a mouse (not shown) a slot at a right-side of an item “Sender” on the delivery service information menu. The A-user inputs by a keyboard (not shown) his name at the slot. Next, the A-user clicks a slot at a right-side of an item “Address” and inputs his address at the slot. As like to steps mentioned above, the A-user inputs items regarding a net address, an article, a size, a weight, a delivery state. Herein, there are items “Room Temp. (Temperature)”, “Perishables”, and “Keep Frozen” as the item “Delivery State”. These three items are elements of a radio button. For example, if the A-user clicks the inside of a check slot at a left-side of the item “Room Temp.”, the check slot is marked with a symbol “.”.

Next, the A-user clicks slots at a right-side of an item “Requested Collect Date” and inputs at the slots the desired date and time when he requests the package to collect by the dealer from the distribution center unit 200. Furthermore, the A-user inputs items regarding (a name of) a receiver, an address (of the receiver), and a net address (of the receiver). Lastly, the A-user clicks a button “Decision”.

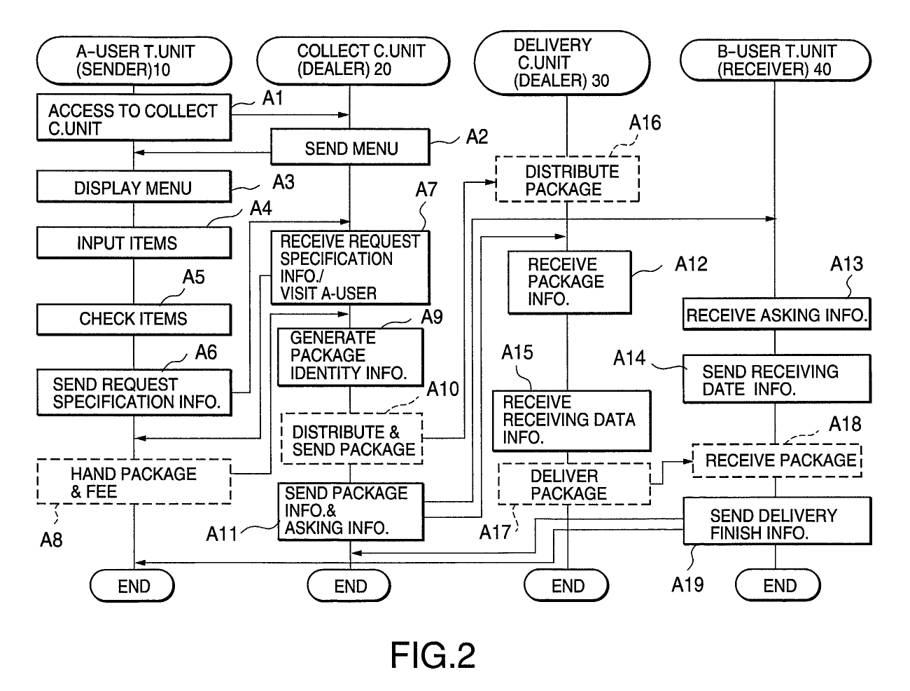

When the button “Decision” is clicked, the A-user terminal unit 10 checks whether items necessary to be input at least (for example, the name, the address, and the net address of the sender, the article, the requested collect date, and the name, the address, and the net address of the receiver) are input or not. Furthermore, the checks whether the net address of the sender is correct in description or not. If the net address of the sender is incorrect, the A-user terminal unit 10 alerts to the A-user by displaying an alert where an incorrect part is on the display. The A-user corrects the incorrect part with referring to the alert displayed and clicks the button “Decision” again. The A-user terminal unit 10 checks again which the net address of the sender is correct or not. If the net address of the sender is correct, the A-user terminal unit 10 displays an information “OK” and so on (Step A5 in FIG. 2). The A-user terminal unit 10 stores the items (an information) which have been input as mentioned above as the request specification information in a storage device thereof such as a hard disk.

When the A-user clicks a button “Order” on the delivery service information menu, the A-user terminal unit 10 sends to the collect center unit 20 the request specification information stored in the storage device through the Internet 100 (Step A6).

The collect center unit 20 receives the request specification information from the A-user terminal unit 10. The dealer who refers to a display of the collect center unit 20 visits the A-user on the desired date and time included in the request specification information in order to receive the package and a fee (Step A7). The dealer checks and/or measures the article, the size, the weight, and the delivery state of the package. The dealer receives the package and the fee (Step A8). The dealer takeouts the package to the collect center and the results checked and measured and collates the results with the request specification information received from the A-user terminal unit 10. Consequently, if at least one item of the request specification information is entered or different from the results, the dealer inputs to the collect center unit 20 so that the item is entered or corrected. Thus, the collect center unit 20 generates a package identity information for specifying the sender, the package, and the receiver (Step A9). The dealer distributes the package for the preparation of sending and sends the package to an applicable delivery center, with referring to the package identity information of the package (Step A10). The collect center unit 20 sends a package information to the delivery center unit 30 and an asking information through the Internet 100 to the B-user terminal unit 40, respectively (Step A11). The package information is generated by the collect center unit 20 by further adding an information for directing the delivery center to deliver the package to the B-user to package identity information. The asking information used for asking the desired date and time for receiving the package at the home of the B-user.

When the delivery center unit 30 receives the package information (Step A12), the delivery center unit 30 finishes distributing the package with referring to the package information before the delivery center receives another package from the collecting center.

On the other hand, the B-user terminal unit 40 receives the asking information from the collect center unit 20 (Step A13). The B-user inquires when he stays at his home and inputs to the B-user terminal unit 40 a receiving date information representing the desired date and time when he requests to receive the package. The B-user terminal unit 40 sends the receiving date information to the delivery center unit 30 through the Internet 100 (Step A14). The delivery center unit 30 receives the receiving date information (Step A15). The dealer of the delivery center distributes the package received from the collect center unit 20 with referring to the receiving date information displayed by the delivery center unit 30. As like to this, the dealer distributes the other packages received from the collect center unit 20 with referring to the other receiving date informations so that the packages are specified into each region where each of the packages will be delivered (Step A16). Next, the dealer of the delivery center delivers the package to the B-user on the desired date and time appointed by the B-user (Step A17). Thus, the B-user receives the package (Step A18).

The dealer of the delivery center unit 30 confirms that the B-user receives the package. The dealer sends, with the use of the B-user terminal unit 40 or the delivery center unit 30, to the A-user terminal unit 10 and the collect center unit 20 a delivery finish information (Step A19). The delivery finish information represents that the package has been delivered to the B-user. Thus, the A-user and the dealer of the collect center know that the package has been delivered to the B-user.

The receiving date information from the B-user terminal unit 40 and the delivery finish information from the B-user terminal unit 40 or the delivery center unit 30 may be sent to the other party by an E-mail and so on, respectively.

Second Embodiment

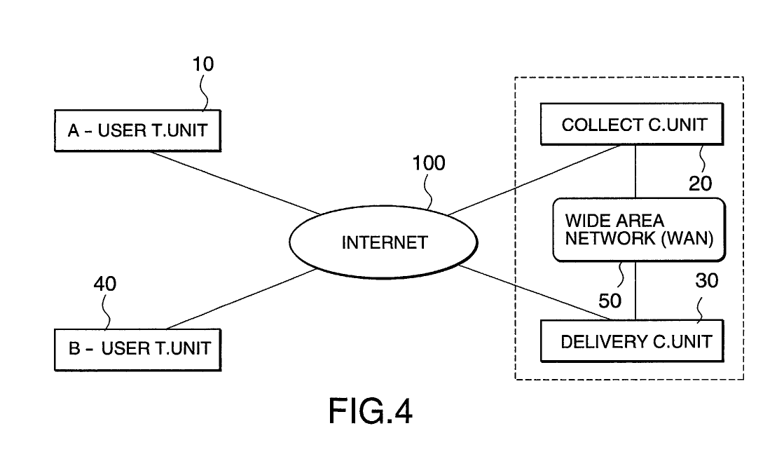

Next, a home delivery system according to a second embodiment of this invention will be described with referring to FIG. 4. In FIG. 4, numerals of parts like to that in FIG. 1 are provided with the same numerals of the parts in FIG. 1 and the parts will be omitted in description.

The collect center unit 20 and the delivery center unit 30 are connected to each other through a wide area network (WAN) 50 and can transmit a variety of informations to each other.

After receiving the request specification information from the A-user terminal unit 10, the collect center unit 20 can generate the package identity information and can send the package identity information to the deliver center unit 30 through the WAN 50 while not sends to the B-user terminal unit 40.

The collect center unit 20 can receive the information. After the dealer of the collect center visits and collects the package from the A-user, the collect center unit 20 can generate the package identity information. The collect center unit 20 can send the package identity information to the delivery center unit 30 through the WAN 50.

After receiving the package identity information from the collect center unit 20 through the WAN 50, the delivery center unit 30 can send, with referring to the package identity information, the asking information to the B-user terminal unit 40 through the WAN 50.

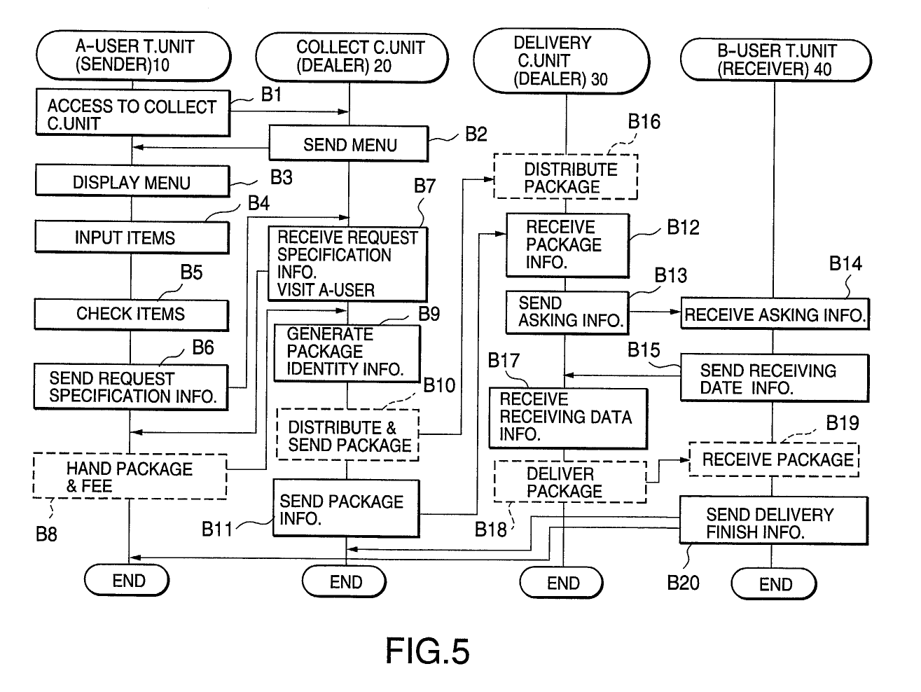

Next, the working of the home delivery system shown in FIG. 4 will be described with referring to FIG. 5.

After sending the request specification information from the A-user by the A-user terminal unit 10 through the Internet 100, the collect center unit 20 receives the request specification information. The dealer of the collect center visits the A-user and collects the package with referring to the request specification. The collect center unit 20 generates the package identity information. The dealer of the collect center distributes the packages and sends the package to the delivery center. Steps mentioned above are Steps B1 to B10 in FIG. 5. Steps B1 to B10 are performed as like to Steps A1 to A10 of the first embodiment.

The collect center unit 20 generates the package information and sends the delivery center unit 30 through the WAN 50 (Step B11). The delivery center unit 30 receives the package information (Step B12). The delivery center unit 30 sends the asking information to the B-user terminal unit 40 through the Internet 100 with referring to the package information (Step B13). Steps B14 to B19 subsequent to Step B13 are worked as like to Steps A13 to A18 of the first embodiment.

The B-user confirms the package. The B-user terminal unit 40 sends to the A-user terminal unit 10 a delivery finish information (Step B20). The delivery finish information represents that the package has been delivered to the B-user.

The receiving date information and the delivery finish information from the B-user terminal unit 40 may be sent to the other party by an E-mail and so on.

Although the collect center unit 20 and the delivery center unit 30 are different as apparatuses from each other in the embodiments, the collect center unit 20 and the delivery center unit 30 may be integrated into a single apparatus. In this state, the function of the delivery center unit 30 may be integrated into the collect center unit 20 while the function of the collect center unit 20 may be integrated into the delivery center unit 30.

The collect center unit 20 and the delivery center unit 30 of the second embodiment may serve as units of a C-dealer and a D-dealer, respectively. In this state, an inter-business network is used instead of the WAN 50.

Furthermore, a program deciphered by a computer system may be provided in order to perform as the collect center unit 20 and the delivery center unit 30. The program may be recorded in a recording medium. The computer system can perform the control by the collect center unit 20 and the delivery center unit 30 based on the program. The computer system implies a software such as an operating system (OS) and a hardware such as a peripheral apparatus.

If the computer system uses the Internet, the computer system further implies a server for providing and/or displaying a webpage.

For example, the recording medium is a portable storage device such as a flexible disk, a magnetic optical (MO) disk, a read only memory (ROM), a compact disc (CD)-ROM, and a hard disk or a storage device installed in the computer system such as a hard disk drive. Furthermore, the recording medium may be a server capable of receiving the program through a network such as the Internet and a communication line such as a telephone line or memorizing means capable of temporarily memorizing the program such as a random access memory (RAM) in a computer system as a client system.

Furthermore, the program may be transmitted individually or with a signal carrier from the computer system storing the program therein through a transmitting medium to the other computer system. Herein, the transmitting medium is, for example, the network such as the Internet and the communication line such as the telephone line.

The program may perform at least one part of the function of the collect center unit 20 and the delivery center unit 30. Furthermore, the program may be a difference file. Namely, the program may perform the function mentioned above in cooperation with the original program of the computer system such as the OS.

While this invention has thus far been described in conjunction with embodiments thereof, it will readily be possible for those skilled in the art to put this invention into practice in various other manners.

What is claimed is:

1. A home delivery system comprising a sender terminal unit installed at a sender end requesting to send a package, a receiver terminal unit installed at a receiver end being to receive the package, and a distribution center unit installed at a distribution center collecting and delivering the package and connected to said sender terminal unit and said receiver terminal unit through a network;
wherein said distribution center unit receives from said sender terminal unit a request specification information for requesting to deliver the package, picks up from said request specification information a sender identity information of the sender end, and generates by referring to said sender identity information a collecting direction information for directing the distribution center to pick up the package.

2. A home delivery system as claimed in claim 1, wherein said request specification information includes a collecting date information representing the desired date and time for pickup the package at the sender end;
said distribution center unit picking up from said request specification information received from said sender terminal unit said collecting date information and generating by referring to said collecting date information a collecting direction information for directing the distribution center to pick up the package on the desired date and time represented by said collecting date information.

3. A home delivery system as claimed in claim 1, wherein said distribution center unit generates by referring to said request specification information a package identity information for specifying the sender, the package, and the receiver, sends to said receiver terminal unit by referring to said package identity information an asking information for asking the desired date and time when the receiver requests to receive the package, receives from said receiver terminal unit a receiving date information representing the desired date and time when the receiver requests to receive the package, and generates by referring to said receiving date information a delivery direction information for directing the distribution center to visit the receiver end and to deliver the package on the desired date and time represented by said receiving date information.

4. A home delivery system as claimed in claim 1, wherein said distribution center unit sends to said sender terminal unit a delivery finish information representing that the package has been delivered to the receiver end.

5. A home delivery method carried out by a home delivery system comprising a sender terminal unit installed at a sender end requesting to send a package, a receiver terminal unit installed at a receiver end being to receive the package, and a distribution center unit installed at a distribution center collecting and delivering the package and connected to said sender terminal unit and said receiver terminal unit through a network;
wherein said distribution center unit carries out the steps of:
receiving from said sender terminal unit a request specification information for requesting to deliver the package;
picking up from said request specification information an identity information of the sender end; and
generating by referring to said identity information a collecting direction information for directing the distribution center to pick up the package.

6. A home delivery method as claimed in claim 5, wherein said request specification information includes a collecting date information representing the desired date and time for pickup the package at the sender end;
said distribution center unit picking up from said request specification information received from said sender terminal unit said collecting date information and generating by referring to said collecting date information a collecting direction information for directing the distribution center to pick up the package on the desired date and time represented by said collecting date information.

7. A home delivery method as claimed in claim 5, wherein said distribution center unit generates by referring to said request specification information a package identity information for specifying the sender, the package, and the receiver, sends to said receiver terminal unit by referring to said package identity information an asking information for asking the desired date and time when the receiver requests to receive the package, receives from said receiver terminal unit a receiving date information representing the desired date and time when the receiver requests to receive the package, and generates by referring to said receiving date information a delivery direction information for directing the distribution center to visit the receiver end and to deliver the package on the desired date and time represented by said receiving date information.

8. A home delivery method as claimed in claim 5, wherein said distribution center unit sends to said sender terminal unit a delivery finish information representing that the package has been delivered to the receiver end.
